(19) United States
(12) Patent Application Publication
(10) Pub. No.: US 2003/0217129 A1
(43) Pub. Date: Nov. 20, 2003

(54) Self-organizing intelligent network architecture and methodology

(75) Inventors: Steven F. Knittel, West Allenhurst, NJ (US); Madhav Moganti, Piscataway, NJ (US)

Correspondence Address: MOSER, PATTERSON & SHERIDAN L.L.P., 595 SHREWSBURY AVE, FIRST FLOOR, SHREWSBURY, NJ, 07702, US

(73) Assignee: LUCENT TECHNOLOGIES INC.

(21) Appl. No.: 10/146,422

(22) Filed: May 15, 2002

(51) Int. Cl. G06F 15/16; G06F 15/173

(52) U.S. Cl. 709/223

(57) ABSTRACT

An intelligent network including a plurality of hierarchal intelligent layers, each layer responsive to communications from at least one of a superior layer and a subordinate layer. A plurality of nodes form each layer, where each of the plurality of nodes have intelligence modules that are interconnected horizontally within each layer, as well as interconnected to intelligence modules of the subordinate and superior hierarchal layers, wherein the intelligence is provided end-to-end of the hierarchal self-organizing intelligent network.

### CROSS-REFERENCES

The present patent application is related to commonly assigned and concurrently filed patent application Ser. No. ______, filed ______ (Attorney Docket: Brancati 1-5-5), entitled “Intelligent End-User Gateway Device,” which is hereby incorporated by reference in its entirety.

### FIELD OF INVENTION

The present invention relates to communication networks. More specifically, the present invention relates to intelligent network architecture.

### DESCRIPTION OF THE BACKGROUND ART

Current communication industry practice generally assumes that networking consists of largely predictable processes that can safely proceed without the benefit of, or need for, in-process measurement and real-time feedback. Most adjustments in networking processes are made by service provider operators that often use intuition and experience to tune parameters. As the technological changes are occurring at a faster pace, there is not enough consideration given to the need for real-time planning or replanning, automatic service adaptability, real-time resource optimization, or adaptability to changing conditions. Real-time schedule changes, provisioning, configuration, and process modifications are handled mostly by manual ad-hoc methods.

Service providers are looking for flexible end-to-end networks to benefit from reduced operations costs, which translate into more competitive, cost-effective service offerings. Unfortunately, a manageable communication network intelligence (CNI) that ties all these separate areas of knowledge into a unified framework has been lacking.

### SUMMARY OF THE INVENTION

The disadvantages heretofore associated with the prior art, are overcome by the present invention of an intelligent network. The intelligent network includes a plurality of hierarchal intelligent layers, each layer responsive to communications from at least one of a superior layer and a subordinate layer.

Each layer is formed by a plurality of nodes, where each of the plurality of nodes has intelligence modules that are interconnected horizontally within each layer. Furthermore, the intelligence modules of each layer are interconnected to intelligence modules of the subordinate and superior hierarchal layers, wherein the intelligence is provided end-to-end of the hierarchal self-organizing intelligent network.

### BRIEF DESCRIPTION OF THE DRAWINGS

The teachings of the present invention can be readily understood by considering the following detailed description in conjunction with the accompanying drawings, in which:

FIG. 1 depicts a flow diagram of functional end-to-end traffic flow for a hierarchal interconnected and layered intelligent network;

FIG. 2 depicts a flow diagram of various elements of network intelligence and their functional relationships;

FIG. 3 depicts a flow diagram representing behavioral and organizational relationships in a hierarchical intelligent network structure;

FIG. 4 depicts a flow diagram illustrating temporal flow activity based on historical and future plan information at each hierarchal level;

FIG. 5 depicts a flow diagram of generation and representation of dynamic traffic matrices;

FIG. 6 depicts a flow diagram representing hierarchically arranged planning information structures;

FIG. 7 depicts a flow diagram of functional end-to-end traffic flow for an automated, self-organizing hierarchal interconnected and layered intelligent network of FIG. 1;

FIG. 8 depicts a flow diagram of dynamically interconnected layered network nodes representing the self-organizing network of FIG. 7; and

FIG. 9 depicts a flow diagram representing intelligence update control flow between an intelligent end-user gateway and intelligent network management.

To facilitate understanding, identical reference numerals have been used, where possible, to designate identical elements that are common to the figures.

### DETAILED DESCRIPTION OF THE INVENTION

Intelligent communication networks require the ability to understand the communications environment, to make decisions, and to efficiently utilize and manage the network resources. Sophisticated levels of intelligence include the ability to recognize various user, application, service provider, and infrastructure needs, as well as expected and unexpected events. The collection of information and the ability to respond in logical actions represents knowledge in a world model, which further enables an intelligent communication network to reason and plan for the future. For purposes herein, communication network intelligence (CNI) is defined as the ability of a network system to act appropriately in an (uncertain) environment, where appropriate action is such action that promotes optimal and efficient use of network resources in delivering high-quality services, and success is the achievement of behavioral sub-goals that support, for example, a service provider's overall goals. Both the criteria of success and the service provider's overall goals are defined external to the intelligent system. The goals and success criteria are typically defined by the business objectives of the service provider and implemented by network designers, programmers, and operators. Network intelligence is the integration of knowledge and feedback into an input-output-based interactive goal-directed networked system that can plan and generate effective, purposeful action directed toward achieving them.

Various degrees or levels of network intelligence are determined by the computational power of the network and network elements, the sophistication of algorithms the system uses for input and output processing, world modeling, behavior generation, value assessment, communication, and the information and data values the network system can access. Accordingly, network intelligence evolves through growth in computational power and through the accumulation of knowledge on the types of input data required, decisions regarding output responses, and processing needed in a complex and changing environment. Increasing sophistication of network intelligence produces capabilities for look-ahead planning and management before responding, and reasoning about the probable results of alternative actions. These abilities of intelligent networks can provide competitive and operational advantage to the service providers over the traditional networks.

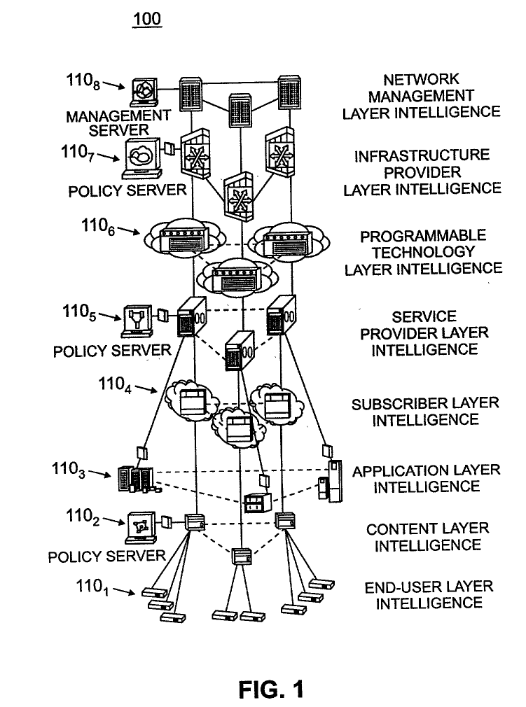

FIG. 1 depicts a flow diagram of functional traffic flow in an end-to-end interconnected and layered intelligent network 100. The illustrative intelligent network comprises a plurality of hierarchal levels 110 including an end-user layer 110₁, a content layer 110₂, an application layer 110₃, a subscriber layer 110₄, a service provider layer 110₅, a programmable technology layer 110₆, an infrastructure provider layer 110₇, and a network manager layer 110₈. A plurality of horizontal traffic flows is provided between the nodes of each layer 110. For example, phantom lines are shown between the exemplary three nodes of the service provider layer 110₅. Similarly, vertical traffic flow is provided between at least adjacent layers. For example, vertical traffic flow is provided between each of the nodes of the network management layer 110₈ and the nodes of the infrastructure provider layer 110₇. In either instance, the traffic flow, in this context, refers to the utilization of intelligent content. These layered flows are used as a foundation on which the framework of network intelligence is developed. Several intelligent network architectures are discussed herein, such as IP centric Optical networks, intelligent service management and delivery, and intelligent IP tunneling with regard to end-to-end network intelligence flow issues.

The end-user intelligence layer 110₁ provides the capabilities needed at the user's premises, which are not normally considered part of the service providers' networks. The importance of the end-user intelligence layer 110₁ is continuing to grow, based on improvements in access bandwidth available to the end-user. Greater bandwidth availability allows for expanded intelligence within the equipment deployed on the customer premises and requires additional functionality and coordination within the service provider space. One advantage is that content may be provided to the user premises in anticipation of user needs, as well as at times of lower utilization on the service provider's network. Additionally, intelligence at the user's layer 110₁ is important in supporting new services that are tailored to the usage patterns and interests of the users.

The content-based intelligent network 110₂ allocates network bandwidth based on the content and user requirements, as well as safeguards content based on defined access policies. The content-based intelligent network 110₂ comprises various services including content location services, content distribution and replication, content caching, as well as content redirection and forwarding.

The emergence of the Internet has radically changed the way individuals and corporations utilize networks and how information is located and accessed. Currently, if a large number of users want to access a “hot” content area at the same time, “flash” network overloads can occur which stress the infrastructure beyond its limits. The service provider networks are changing the information delivery mechanism from passive content retrieval to proactive content delivery based on network policies and user identity. The passive retrieval model requires a network infrastructure that is built for predictable network and server loads. The proactive delivery model requires that content be intelligently distributed closer to clients and network access points to better cope with sporadic network loads driven by hot content. In the content-based intelligent paradigm, an end user's customer premise equipment (CPE) or device deals with content in the network directly. A content-aware CPE device requires a content-based intelligent network environment that facilitates the distribution of content requests to locations where the content is requested. This minimizes unnecessary network loads that result from focused overloads or backbone constraints.

The application layer intelligence 110₃ allows application service providers to more effectively manage application resources to their maximum utilization and return on investment. In particular, the number of applications offered to the end-users that must be supported continues to grow. The traffic carried to support the applications generates different traffic load and flow patterns, which are dependent on various characteristics of the applications. These characteristics of applications include real-time and non real-time, computation intensive and non-intensive, network topology dependent and independent, end user dependent and independent, high bandwidth and low bandwidth, and delay sensitive and insensitive characteristics.

In order to properly design, evaluate, and deploy efficient network gear for an application environment, a service provider requires better understanding of the source models of the network application traffic. In particular, one would like to find invariant (of application traffic) characteristics of how an application host generates network traffic. Based on application architectures, design, and human factors, there are a number of reasons why application traffic may vary significantly, such as, user access type, application communication methods, single transaction vs. multiple linked transaction applications, and end user input and interaction strategy.

The subscriber-based intelligent network environment 110₄ consists of a group of customer premise equipment (CPE) or devices communicating and sharing one or more resources in a decentralized way. The subscriber-based intelligent network environment 110₄ is depicted by clouds in FIG. 1, which represent virtual entities or soft devices. This type of networking demands certain relationships between the service providers network elements and the CPE devices. Some of these applications demand particular logical network topologies to enable the applications. For example, peer-to-peer network applications, cluster-computing, networked parallel processing, and mapping of logical storage area networks on physical/virtual network topologies are examples of subscriber-based intelligence. The advantage of this approach is to speed-up algorithm execution, minimize inter-node communication delays, improve resource utilization, and provide fault-tolerance by restoring the network connectivity on the occurrence of faults. Features and services can be highly personalized to pre-designated user groups or to an individual using them. In this environment, a user has the choice to select preferred network resource characteristics to activate personalized features and provide information to the system that will improve its performance.

The service provider layer intelligence 110₅ provides the options to carry the end users' traffic by applying service provider constraints to end users needs. Examples of service provider intelligence 110₅ include intelligent tunneling, virtual network switching or routing (using VPNs), and VLANS. The service provider layer illustratively provides various features, such as, quality of service (QoS), isolation, and policing capabilities that allow service providers to deliver flexible, measurable, and enforceable Service Level Agreements (SLA) to other service providers as well as to subscribers, while allowing the delivery of real-time and non real-time services from multiple sources. These features enable a service provider to provide other large service providers with dedicated virtual resources, as well as allow small service providers to share virtual resources that are administratively managed by the service provider.

The programmable technology layer intelligence 110₆ provides interoperability and adaptability across heterogeneous networks that support a wide range of signaling protocols. The programmable technology layer intelligence 110₆ is depicted with clouds in FIG. 1, which represent virtual entities or soft devices. Programmable switches (e.g., like SOFTSWITCH™) translate industry-signaling protocols into a generic call-signaling format, thereby simplifying the addition of new protocols. This capability allows legacy service providers and new service providers to provide rich, seamless interoperability between their network domains, and enables signaling interworking between multiple vendor gateways. The programmable technology layer intelligence 110₆ enable applications to better react to changing conditions, thereby enabling applications to pro-actively optimize physical layer performance using some application-defined set of metrics.

The infrastructure provider layer intelligence 110₇ allows service providers to build networks capable of supporting a variety of old and new infrastructures, as well as providing new value added services and reduction in costs. The unique problems inherent in simultaneously supporting an existing network, while deploying a new multi-service infrastructure point to a solution that leverages the unique benefits of FR, ATM, IP, and dense wave division multiplexing (DWDM) technologies. The infrastructure layer intelligence 110₇ provides the capabilities to deal with these complexities, such as technologies like DWDM and multi-service platforms. The infrastructure layer intelligence 110₇ may operate in multi-vendor environments, multi-technological environments, and multi-protocol environments.

The network management layer intelligence 110₈ deploys, integrates, and coordinates all the resources necessary to configure, monitor, test, analyze, evaluate, and control the communication network to meet service-level objectives. The driving forces for network management are efficient use of resources, control of strategic assets, minimization of down time, management of constantly changing communications technology and services, and reduction of the cost of the network operations. The network management layer must intelligently integrate diverse services, networks, technologies, and multi-vendor equipment. It is noted that although the network management layer intelligence 110₈ is depicted as a separate layer, in some network management functions the network management layer intelligence 110₈ is distributed across the other layers embedded in element management systems. However, for simplicity and convenience, such embedding is not shown.

In an end-to-end communications network 100, the phenomena of overall network intelligence requires more than a set of disconnected elements. Overall intelligence in networks requires an interconnecting and functionally tightly coupled system architecture that enables the various functional levels to interact and communicate with each other in several ways. That is, the network intelligence considers and responds to the dependence of one layer on the other layer, the effect of change in one layer and impact and proliferate to the other layers, inter relationships between these several layers, the effect of changes in the network environment in view of each of the layers and the overall network, and the impact of the addition of new technologies, new applications, and new services.

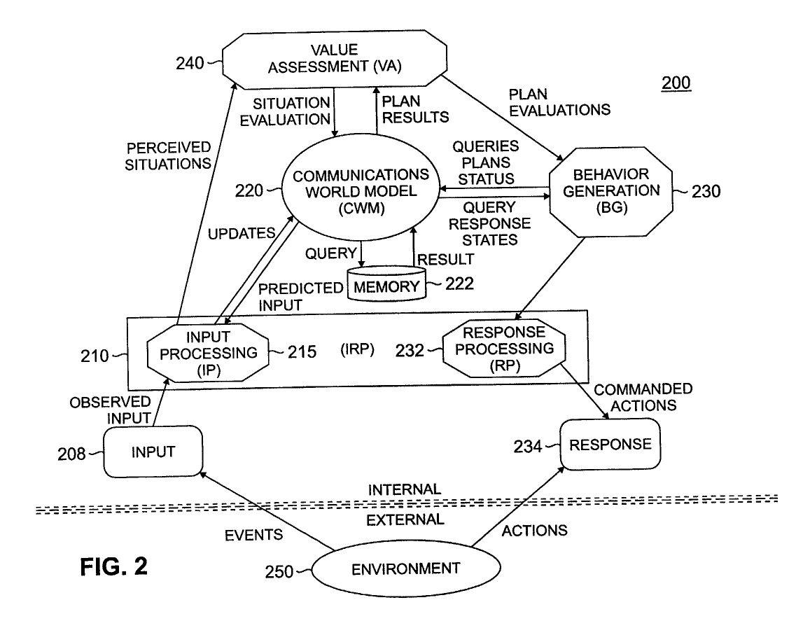

FIG. 2 depicts a flow diagram of various modules of network intelligence and their functional relationships. In one embodiment, the end-to-end interconnected and layered intelligent network 100 comprises an end-to-end system level intelligence formed by a plurality of intelligence modules 200. Each intelligence module 200 comprises an input processing (IP) module 215, a response processing (IR) module 232, a communications world modeling (CWM) module 220, a behavior generation (BG) module 230, and a value assessment (VA) module 240. For simplicity the input processing 215 and response processing 232 modules are collectively referred to as an input-response processing (IRP) module 210. Referring to FIG. 1, each node at each horizontal layer (i.e., layers 110₁ through 110₈) has a corresponding “module” for providing the IRP 210, CWM 220, BG 230, and VA 240. The nodes and respective modules aggregately form a system level intelligent network 100, by cumulatively interacting together in both a horizontal and vertical (end-to-end) hierarchically structure.

Data structures for representing explicit knowledge are defined to reside in a knowledge database 222 that is hierarchically structured and distributed such that there is a knowledge database for each CWM module 220 in each node at every layer of the system hierarchy. The communication system provides services that make the CWM modules 220 and the knowledge database 222 behave like a global virtual common memory in response to queries and updates from the BG, IRP, and VA modules 230, 210, and 240. The communication interfaces with the CWM modules 220 in each node provides a window into the knowledge database for each of the computing modules in that node.

An input 208 to an intelligent network system 100 is produced by interactions with the network environment 250. For example, input to an intelligent network system 100 is produced by end-user interactions, which may include end-user behavior, such as type of information sought, quality of information sought, ability to use higher bandwidths at higher prices, types of services requested, time spent on the network, nature of user, among others. Inputs 208 may be used by the intelligent network system 100 to monitor both the state of the external world and the internal state of the network system 100, itself.

The input processing system module 215 receives the inputs to the intelligent network system 100, and compares input observations with expectations generated by the internal communications world model 220. Input processing algorithms integrate similarities and differences between observations and expectations over time and space to detect events and recognize features, patterns, and relationships in the external world. The input data from a wide variety of sources over extended periods of time are fused into a consistent unified perception of the state of the communications world. Input processing algorithms compute several network system characteristics, including both physical and logical dynamic attributes of objects and events of interest. For example, the translation of Internet Protocol (IP) addresses using end user's input content and then learning from the previous interactions with the network.

Response 234 in an intelligent network system is produced by the response processing system 232, which makes it possible to communicate effectively with and to interact with the network environment. For example, response from a circuit-packet gateway switch could be the translation of a circuit signaling protocol to a packet signaling protocol to enable communication with the packet network.

Response processing 232 in an intelligent network system is the result of the execution of behavior generation algorithms upon the communications world model 220. For example, an output response 234 of an intelligent network system 100 that includes, for example, the All-Optical Lambda Router manufactured by Lucent Technologies of Murray Hill, N.J., may be produced by micro-mirror actuators that move, and align themselves to cross-connect wavelengths dynamically. A particular node (e.g., router) of the intelligent network system 100 may have hundreds of such micro-motored actuators, all of which must be coordinated in order to perform end-to-end tasks and accomplish a service provider's dynamic routing needs.

The communications world model (CWM) 220 is the intelligent network systems best estimate of the state of the world of the network and its environment. The communications world model 220 includes a database (e.g., distributed main memory database) 222 for storing information (i.e., “knowledge”) about the network 100 and its environment 250, plus a database management system that stores and retrieves information. The communications world model 220 also contains a capability that generates expectations and predictions about the network resources, operations, usage, and the like. The communications world model module 220 can respond to requests for information about the present, past, and probable future states of the world.

The communications world model module 220 provides information services to the behavior generation system module 230 to enable intelligent planning and behavioral choices, and to the input processing system element 215 for performance of correlation, matching, as well as recognition of states, patterns, and events. Additionally, the communications world model 220 provides information to the value assessment system module 240, which computes values such as cost, benefit, risk, uncertainty, importance, attractiveness, among other value related information.

The communications world model 220 is kept current by the input processing system 215. Various classifications of information may be inputted by the input processing system 215, such as a demography database of a country, customer needs, market needs, service profiles, logical network topologies, and customer service level agreements.

The communications world model (CWIM) 220 provides the intelligent network system 100 with the information necessary to reason about network services, network needs, network resources, and time. The communications world model 220 contains knowledge of things that are not directly and immediately observable. It enables the system to integrate input from many different sources into a single reliable representation of network domain. The world knowledge may be represented in intelligent network systems by data in database structures such as traffic matrices, traffic estimates, service profiles, policy agreements, and the like.

The communications world model 220 is formed by an aggregate of communications world model modules at each node of the network hierarchy. CWM modules maintain the knowledge database by keeping the knowledge current and consistent. In this role, the CWM modules perform the functions of a database management system. The CWM 220 provides estimates that are updated based on correlations and differences between communications world model predictions and input data observations at each intelligent node. The CWM modules 220 save newly generated/recognized entities, states, and events into the knowledge database, and delete entities and states determined by the input processing modules that no longer exist in the communications environment. The CWM modules 220 also enter estimates, generated by value assessment modules 240, of the reliability of communications world model state variables.

CWM modules 220 generate predictions of expected input values for use by the appropriate input processing modules 215. In this role, a CWM module 220 performs the functions of a state predictor, generating predictions that enable the input processing system 215 to perform correlation and predictive filtering. CWM predictions are based on the state of the task and estimated states of the external world.

The CWM modules 220 answer “What is?” questions asked by the planners and executors in the corresponding level behavior generation (BG) modules 230. Estimates formed by the communications world model modules regarding the current state of the network 100 and its environment are also used by BG module planners as a starting point for planning.

The CWM modules 220 also answer “What if?” questions asked by the planners in the corresponding level BG modules 230. In this role, the CWM modules 220 perform the function of simulation by generating expected status resulting from actions hypothesized by the BG modules 230. Results predicted by CWM simulations are sent to the value assessment (VA) modules 240 for evaluation. For each hypothesized action generated by the BG modules 230, a CWM prediction is generated, and a VA evaluation is returned to the BG modules 230. This BG-WM-VA 230-220-240 coupling enables the BG modules 230 to select the sequence of hypothesized actions producing the best evaluation as the plan to be executed.

The communications world model knowledge database 222 contains both a priori information that is available to the intelligent network system 100 before action begins, and a posteriori knowledge that is gained from monitoring the environment as network functions. The communications world model knowledge database 222 contains information about space, time, entities, events, and states of the network elements and the network environment. For example, a priori information may include the knowledge that an optical transport node receives data in the range of (100 Mbps—minimum, 400 Mbps—most likely, 600 Mbps—maximum) every Monday between 1 PM and 2 PM for the past one year. The knowledge database 222 also includes information about the intelligent system itself, such as values assigned to goals, objects, and events; parameters embedded in dynamic models of the virtual routes and optical paths; plus the states of all of the processes currently executing in each of the BG 230, IRP 210, CWM 220, and VA 240 modules.

Knowledge about the traffic engineering rules, network element constraints, capacities, and the rules of logic and mathematics are represented as parameters in the CWM functions that generate predictions and simulate results of hypothetical actions. Physical knowledge may be represented as algorithms, formulae, or as IF/THEN rules of what happens under certain situations, such as when a network node fails, a link is cut, a new service request appears, and the like. The correctness and consistency of communications world model knowledge is verified by input processing mechanisms that measure differences between communications world model predictions and collected trace observations.

The communications world model 220 contains information about network entities stored. The knowledge database 222 contains a list of all the entities that the intelligent network system 100 knows about. A subset of this list is the set of current-entities known to be present in any given situation. A subset of the list of current entities is the set of entities-of-attention. There are two types of entities: generic and specific. A generic entity is an example of a class of entities. A generic entity frame contains the attributes of its class. A specific entity is a particular instance of an entity. A specific entity frame inherits the attributes of the class to which it belongs.

Table 1 below depicts an illustrative entity structure.

TABLE 1

| GENERIC | SPECIFIC |
|---|---|
| Entity name | name of entity |
| Kind | class |
| Type | generic or specific |
| Area Access | transport, routing, switching |
| Position | world/virtual map coordinates |
| Dynamics | mobile, fixed |
| Path | sequence of positions/routes |
| Geometry | size, shape |
| Links | sub-entities, parent entity |
| Properties | physical, logical, topology |
| Behavioral | protocols, standards, semantics |
| Performance | delay, loss, load characteristics |
| Reliability | availability, fault-tolerance |
| Capabilities | bandwidth, range, configuration types, |
| | capacity |
| Interfaces | communication, and control-interfaces |
| Value state-variables | success-failure, thresholds |
| | COS parameters |
| Management | provisioning, administration, and |
| | configuration |
| Security | access control lists, filters |

Map and entity representations are cross-referenced and tightly coupled by real-time computing hardware. Many of the attributes in an entity frame are time dependent state-variables. Each time dependent state-variable may possess a short-term memory queue, which describes its temporal history. At each node, temporal traces stretch backward at least to the extent that the planning horizon at that level stretches into the future. At each hierarchical level, an historical trace of an entity state-variable may be produced, by summarizing data values at several points in time throughout the historical interval. Each state-variable in an entity frame may have value state-variable parameters that indicate levels of confidence, support, or plausibility, and measures of dimensional uncertainty. The value state-variable parameters are computed by value assessment functions that reside in the VA modules 240.

The CWM database 222 is hierarchically structured. In particular, each entity in the CWM database 222 comprises of a set of sub-entities, and is part of a parent entity. For example, a network resource (hardware/software) may consist of a set of network components (hardware/software), and be part of a larger network resource. An intelligent network node is task (or goal) driven. The structure of the communications world model entity database 222 is defined by the nature of goals and tasks.

An event in an intelligent network node is a state, condition, or situation that exists at a point in time, or occurs over an interval in time. Events are represented in the communications world model 220 with attributes, in time and space signifying when the event occurred, or is expected to occur. Event attributes may indicate start and end time, duration, type, relationship to other events, and the like. One example of an event structure is shown below in Table 2.

TABLE 2

| GENERIC | SPECIFIC |
|---|---|
| EVENT NAME | name of event |
| Kind | class |
| Type | generic or specific |
| Modality | voice, video, data, etc |
| State | simple, composite, pseudo, final |
| Time | when event detected |
| Interval | period over which event took place |
| Position | map location where event occurred |
| Links | sub-event, parent event |
| Guard | boolean expression attached to a |
| | transition |
| Transition | relationship between a start and |
| | final state |
| Alarms | visual, message |
| Value | benefit-cost, risk |

State-variables in the event structure may have confidence levels, degrees of support and plausibility, and measures of dimensional uncertainty similar to those in spatial entity frames. Confidence state-variables may indicate the degree of certainty that an event actually occurred, or was correctly recognized. Behavior results from a behavior generating system that selects goals, and plans and executes tasks. Tasks are recursively decomposed into subtasks, and subtasks are sequenced to achieve goals.

Goals are selected and plans generated by a looping interaction between behavior generation, world modeling, and value assessment elements. The behavior generating system 230 hypothesizes plans, the communications world model 220 predicts the results of those plans, and the value assessment system 240 evaluates those results. The behavior generating system 230 selects the plans with the highest evaluations for execution. The behavior generating system 230 also monitors the execution of plans, and modifies existing plans whenever the situation requires. For example, events such as congestion, network node overload, or major changes in traffic patterns should be quickly detected, and appropriate corrective actions should be taken to resolve the situations.

Behavior in an intelligent network 100 or network node is the result of executing a series of tasks. A task is a piece of work to be done, or an activity to be performed. For an intelligent network system, there exists a set of tasks that the system knows how to do. Each task in this set is assigned a name. The task vocabulary is the set of task names assigned to the set of tasks the system is capable of performing. The task vocabulary is expanded through learning, training, or programming. Typically, one or more intelligent agents perform a task on one or more entities. The performance of a task may be described as an activity that begins with a start-event and is directed toward a goal-event. A goal is an event that successfully terminates a task. A goal is the objective toward which task activity is directed. A task command is an instruction to perform a named task. An exemplary task command may have the following form:

DO TaskName(parameters)>AFTER <Start Event>UNTIL <Goal Event>

Task knowledge is knowledge of how to perform a task, including information as to what algorithms, protocols, parameters, time, events, resources, information, and conditions are required, plus information as to what costs, benefits, and risks are expected. In a network node, task knowledge may be expressed implicitly in algorithms, software, and hardware. Task knowledge may also be expressed explicitly in data structures, or in a network node database. A task frame is a data structure in which task knowledge can be stored. In systems where task knowledge is explicit, a task frame may be defined for each task in the task vocabulary. An exemplary task frame is shown below in Table 3.

TABLE 3

| GENERIC | SPECIFIC |
|---|---|
| TASKNAME | name of the task; |
| Type | generic or specific; |
| Actor | agent performing the task; |
| Action | activity to be performed; |
| Object | thing to be performed; |
| Object | thing to be acted upon; |
| Goal | event that successfully terminates or |
| | renders the task successfully; |
| Parameters | priority; |
| | status (e.g., active, halted, waiting, |
| | inactive); |
| | timing requirements; |
| | source of task command; |
| Requirements | tools, time, resources, events, etc needed |
| | to perform the task; |
| | enabling conditions that must be satisfied |
| | to begin, or continue, the task; |
| | information that may be required; |
| Procedures | a state-graph or state-table defining a plan |
| | for executing the task; |
| | functions that may be called; |
| | algorithms that may be needed; |
| Effects | expected results of task execution; |
| | expected costs, risks, benefits; and |
| | estimated time to complete. |

Explicit representation of task knowledge in task structures has a variety of uses. For example, network planners and operators may use task structures for generating hypothesized actions. The communications world model 220 may use task structures for predicting the results of hypothesized actions. The value assessment system 240 may use task structures for processing, how important the goal is, and how many resources to expend in pursuing task knowledge. Plan executors may use task structures for selecting what to do next.

Task knowledge is typically difficult to discover, but once known, can be readily transferred to others. Task knowledge may be acquired by trial and error learning, but more often, task knowledge is acquired from experts, or from previous event history. In most cases, the ability to successfully accomplish complex tasks is more dependent on the amount of task knowledge stored in task structures than on the sophistication of planners in reasoning about tasks.

Behavior generation 230 is inherently a hierarchical process. At each level of the behavior generation hierarchy, tasks are decomposed into subtasks that become task commands to the next lower level. At each level of a behavior generation hierarchy there exists a task vocabulary and a corresponding set of task structures. Each task structure contains a procedure state graph. Each node in the procedure state-graph must correspond to a task name in the task vocabulary at the next lower level.

In the network intelligence architecture, each level of the hierarchy contains one or more BG modules 230. At each level, there is a BG module 230 for each network layer/function. The function of the BG modules 230 is to decompose task commands into subtask commands. Input to BG modules 230 consists of commands and priorities from BG modules 230 at the next higher level, plus evaluations from nearby VA modules 240, plus information about past, present, and predicted future states of the world from nearby CWM modules 220. Output from BG modules 230 may consist of subtask commands to BG modules 230 at the next lower level, plus status reports, plus “What Is?” and “What If” queries to the CWM modules 220 about the current and future states of the world.

The value assessment system element 240 is used to determine the goodness and badness, importance, risk, and probability associated with the events and actions involved in the intelligent network 100. The value assessment system 240 evaluates both the observed state of the world and the predicted results of hypothesized plans. The value assessment system 240 computes costs, risks, and benefits both of observed situations and of planned activities, as well as the probability of correctness and assigns believability and uncertainty parameters to state variables. The value assessment system 240 provides the basis for making decisions, and for choosing one response as opposed to another.

For example, the challenge to today's service providers is to provision and meet QoS-based Service Level Agreements (SLAs). When SLAs cannot be met, traffic congestion controls should minimize penalties and maximize revenues when deciding which traffic to admit. If the monitoring process indicates that a customer contracted offer is not being satisfied, then the service provider is non-compliant such that every lost flow contributes to a penalty in the VA module 240.

Referring to FIG. 2, the inter-network functional layer communications includes queries and task status communicated from the BG modules 330 to the CWM modules 220, and retrieval of information from the CWM modules 220 is communicated back to the BG modules 230 making the queries. Predicted input data is communicated from CWM modules 220 to IRP modules 210, while updates to the communications world model 220 are communicated from the IRP modules 210 to the CWM modules 220. Observed entities, events, and perceived situations are communicated from the IRP modules 210 to the VA modules 240, while values assigned to the communications world model representations of these entities, events, and perceived situations are communicated from the VA modules 240 to the CWM modules 220. Hypothesized plans are communicated from the BG modules 230 to the CWM modules 220, and plan results are communicated from the CWM modules 220 to the VA modules 240. Furthermore, plan evaluations are communicated from the VA modules 240 back to the BG modules 230 that hypothesized the plans.

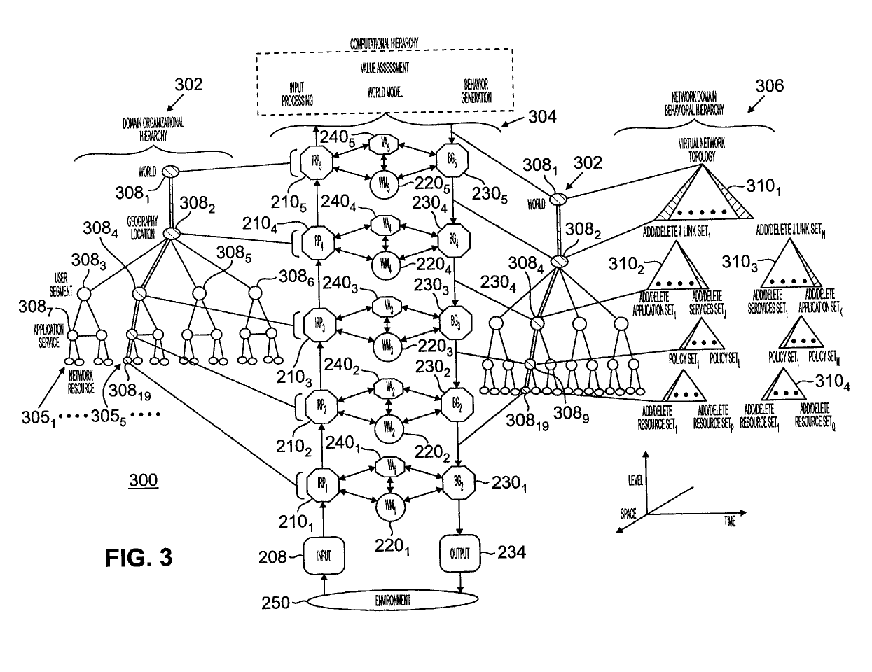

FIG. 3 depicts a flow diagram representing behavioral (temporal) and organizational (spatial) relationships in a hierarchical intelligent network structure 300. FIG. 3 is divided into three portions comprising a domain organizational hierarchy 302 on the left of the drawing, a computational hierarchy 304 in the center, and a network domain behavioral hierarchy 306 on the right of the drawing. For purposes of clarifying the invention, the organization hierarchy 302 is repeated between the computational hierarchy 304 and behavioral hierarchy 306. The organizational hierarchy 302 comprises a tree of command centers 308₁ through 308ₜ (collectively command centers 308). A tree of command centers 308 defines plurality of organizational hierarchy chains 305, through 305_{c}, where each command center 308 may possess at least one of supervisor and/or one or more subordinate command centers. For example, command center 308₂ is supervised by command center 308₁ and has subordinate command centers 308₃ through 308₆.

The computational hierarchy 304 comprises the BG, WM, IRP, and VA modules 230, 220, 210, and 240, as discussed above with regard to FIG. 2. That is, a BG, WM, IRP, and VA module 230, 220, 210, and 240 is provided for each command center 308 at each hierarchal level. A computational hierarchy 304 services each response and each input. For example, a computational hierarch 304 is shown in FIG. 3 for the organization hierarchy chain 305₅ comprising command centers 308₁₉, 308₉, 308₄, and 308₁.

The behavioral hierarchy 306 comprises event progression through state-time-space. Vectors, (or points in state-space) illustratively represent commands at each level. Sequences of commands may be represented as trajectories through state-time-space. At each functional level, the nodes, as well as computing modules within the nodes, are tightly interconnected to each other. Within each computational node, the communication system provides inter-network functional layer communications of the following type, as shown in FIG. 2.

The communications system also communicates between functional layers at different levels. For example, instructions/commands are communicated downward from supervisor BG modules 230 in one level to subordinate BG modules 230 in the level below. Feedback/status reports are communicated back upward through the communications world model 220 from lower level subordinate BG modules 230 to the upper level supervisor BG modules 230 from which commands were received and vice versa. Observed entities, events, and perceived situations detected by IRP modules 210 at one level are communicated upward to IRP modules 210 at a higher level. Predicted attributes of entities, events, and situations stored in the CWM modules 220 at a higher level are communicated downward to lower level CWM modules 220. Input to the bottom layer IRP modules 210, is communicated from input information 208 collected for different sources. Furthermore, output from the bottom level BG modules 230₁ is communicated to the response sub-system 234.

The intelligence within the network system can be realized in a variety of ways. One way of implementation of intelligence functions may be to embed the intelligence (i.e., IRP, WM, BG and VA modules 210, 220, 230, and 240) into the network management system and the network node elements. The communication between the management system and network elements can be achieved using a management communication network. In the system architecture described herein, the input/output relationships of the communications system produce the effect of a virtual global network where its functionality could be equated to a blackboard system.

The input command string to each of the BG modules 230 at each layer 110 generates a response through state-space as a function of time. The set of all command strings create a behavioral hierarchy (represented by the triangles 310₁ through 310ᵤ), as shown on the right of FIG. 3. Each triangle 310 represents a set of possible behavioral paths between each hierarchal layer 110. In particular, the top triangle 310₁ illustratively comprises n behavioral paths between the first command center 308₁ and the second command center 308₂. The striped shaded area represents a first behavioral path such as “Add/Delete a first wavelength (λ) link set 1”, while the n^{th} behavioral path of the first triangle 310 is “Add/Delete a n^{th} wavelength link set n”. The shaded areas of the triangles 310 of FIG. 3 illustratively show the behavioral hierarchy path corresponding to the shaded organizational hierarchy chain 305₅.

For purposes of understanding the hierarchal information flow, at and between each layer 110 of FIG. 3, an example is provided. An input 208 provided to an exemplary command center 308₁₉, corresponding to a network resource at the lowest level layer 110₁ is processed by the input processing (IP₁) 215₁, response processing (RP₁) 232₁. The communications world model (CWM), behavioral generation (BG), and value assessment (VA) modules 220₁, 230₁, and 240₁ interact with the IP₁ 215₁ and RP₁ 232₁ as discussed above with regard to FIG. 2.

Observed entities, events, and perceived situations detected by the IRP module 210₁ at the first hierarchal level layer 110₁ I are communicated upward to the second IRP modules 210₂. The same interaction between the IRP, WM, BG, and VA modules 210₂, 220₂, 230₂, and 240₂ at the second level layer 110₂ are performed, as discussed with regard to FIG. 2, and so forth up the illustrative organizational hierarchy chain 305₅. Similarly, the behavioral generation modules 230 at each level generates a response to a subordinate BG 230, such that the intelligent system network 100 generates information for consideration by both superior and subordinate hierarchal levels, thereby providing end-to-end intelligence throughout the network 100.

Each layer 110 in the behavior generating hierarchy 306 is defined by temporal and spatial decomposition of goals and tasks into levels of differing granularity. Temporal granularity is manifested in terms of bandwidth, sampling rate, and state-change intervals. Temporal span is measured by the length of historical traces and planning horizons. Spatial granularity is manifested in the branching of the task tree, while spatial span is measured by the extent of control and the range of service/application/user domains.

Levels in the input processing hierarchy are defined by temporal and spatial integration of input data into levels of aggregation. Spatial aggregation can be best illustrated by environmental characteristics like demography, geography, etc. Temporal aggregation is best illustrated by day and seasonal parameters such as busy hour, busy season, and the like.

Levels in the communications world model hierarchy are defined by temporal granularity of events, spatial granularity of the service/application/user domain, and by parent-child relationships between network entities (e.g., service nodes serving access nodes, which are serving customer premises nodes). These are defined by the needs of both IRP and BG modules 210 and 230 at the various levels 110.

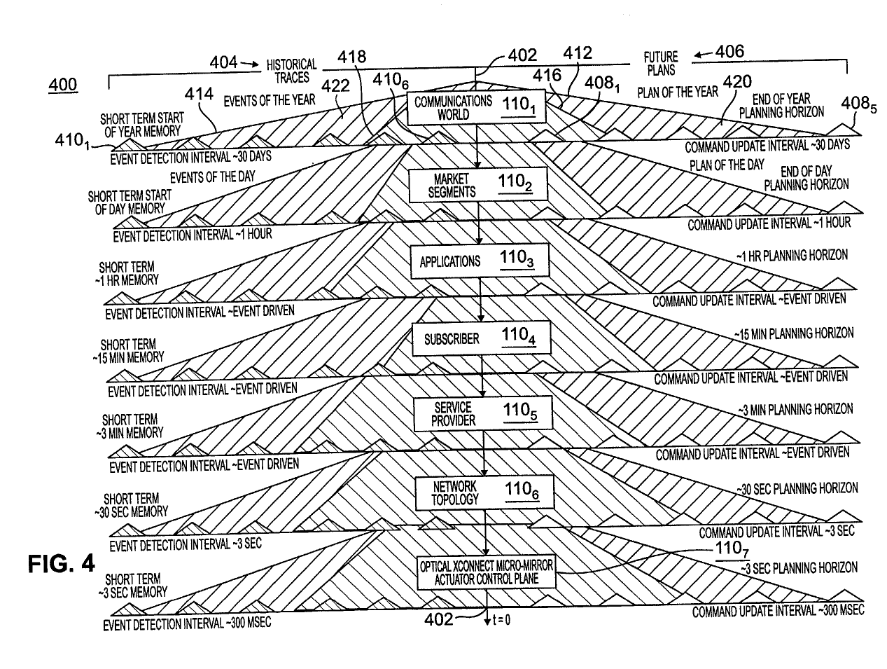

FIG. 4 depicts a flow diagram illustrating temporal flow activity 400 based on historical and future plan information at each hierarchal level 110. In particular, seven adjacent hierarchal layers 110₁ through 110₇ are illustratively shown along a time axis 402. The origin of the time axis 402 in FIG. 4 is the present, where t=zero (0). Future plans 406 are defined to the right of t=0, while historical plans (past history) 404 is defined to the left of t=0. At each hierarchal layer 110, there is a planning horizon 412 and a historical event summary interval 414.

Fulfilled task goals 410 are represented by shaded triangles 410₁ through 410ₜ under the historical plans region 404 of FIG. 4. That is, the shaded triangles 410 in the left half-plane of FIG. 4 represent recognized task-completion events in the past history 404. The heavy shaded (brick) region 418 under the historical plans area 412 (t<0) shows the event summary interval for the current tasks. The lightly shaded area 422 under the historical plans area 404 (t<0) indicates the event summary interval for the immediately previous tasks 410.

Unfulfilled task goals 408 are represented by empty triangles 408₁ through 408ₛ under the future plans region 406 of FIG. 4. The heavy shaded (brick) region 416 under the future plans region 406 (t>0) shows the planning horizon for the current tasks 408. The lightly shaded area 420 under the future plans area 406 (t>0) indicates the planning horizon 412 for the anticipated next task.

In the intelligent communications system 100 depicted herein, which is hierarchically structured, goal-driven, and interactive based on inputs and responses, the following characteristics are noted. Communication bandwidth decreases about an order of magnitude at each higher level. Computational granularity of spatial and temporal patterns decreases about an order-of-magnitude at each higher level. Goals expand in scope and planning horizons expand in space and time about an order-of-magnitude at each higher level. Furthermore, at each higher level, models of the world and memory requirements of events decrease in granularity, while expand in spatial and temporal range by about an order-of-magnitude.

Referring to FIG. 4, the range of the time scale increases, and time resolution decreases exponentially by about an order of magnitude at each higher level. Hence, the planning horizon and event summary interval increases and the communication bandwidth and frequency of sub-goal events decreases, exponentially at each higher level. Network traffic monitoring techniques implicitly assume the above-mentioned four conditions. The seven hierarchical levels 110 shown in FIG. 4 span a range of time intervals from few milliseconds at the first level 110₁ to one year at the illustrative top level 110₇. One year is illustratively selected as the longest historical-memory/planning-horizon to be considered. However, shorter time intervals may be handled by providing additional layers at the bottom. Longer time intervals could be treated by additional layers at the top, or by increasing the difference in communication bandwidths and input and response clustering intervals between levels.

The timing diagram of FIG. 4 illustrates the temporal flow of activity in the task decomposition and input processing systems. At the world level 110₇, high-level input events and periodic user, server, application, market behaviors, and daily routines generate plans for the day, year, and the like. Each element of the plan is decomposed through the remaining six levels of task decomposition into action.

FIG. 4 suggests a duality between the behavior generation and the input processing hierarchies. At each hierarchical level 110, planner modules decompose task commands into strings of planned subtasks for execution. At each level 110, events are summarized, integrated, and clustered into single events at the next higher level. A high-level formalized event specification language can be used to capture events.

The following example describes how the spatial and temporal attributes are captured in the communications world model and used by the behavior generation modules 230. The example presented covers an intelligent all-optical DWDM networks layer. An all-optical network uses optical cross-connects to route wavelengths. Using, for example, a lambda-router by LUCENT TECHNOLOGIES™, wavelengths (λ) can be assigned and provisioned on demand in a transport network. This allows a service provider to offer dynamic bandwidth delivery in seconds. Traditionally transport networks are dimensioned using busy hour/busy season traffic and static traffic matrices. Dynamic bandwidth trading requires calculating routes and traffic flows dynamically in real-time. Dynamically calculating routes and traffic flows requires maintenance of dynamic traffic matrices. Traditional transport network designs, because of their static nature, allow network planners and service provider operators to dimension and fine-tune designs using tools. With the dynamic traffic matrices, human intervention is not possible because of the dynamic nature of the traffic and the quantity of information to be handled. The example herein presents an outline for automatic generation of dynamic traffic matrices for use by an intelligent optical network layer.

Assume that a service provider is offering bandwidth delivery on-demand by using an all-optical transport network, where traffic changes every few minutes and the network logical topology needs to be computed accordingly. It is further assumed that the communications world model in the intelligent optical layer monitors and keeps track of the historical traffic matrices in its database. Also, assume that the world model, with the help of input processing modules 215, generates traffic patterns, up to date service profiles, customer service policy agreements, and subscriber growth estimates. Using all the above information, traffic estimates are generated.

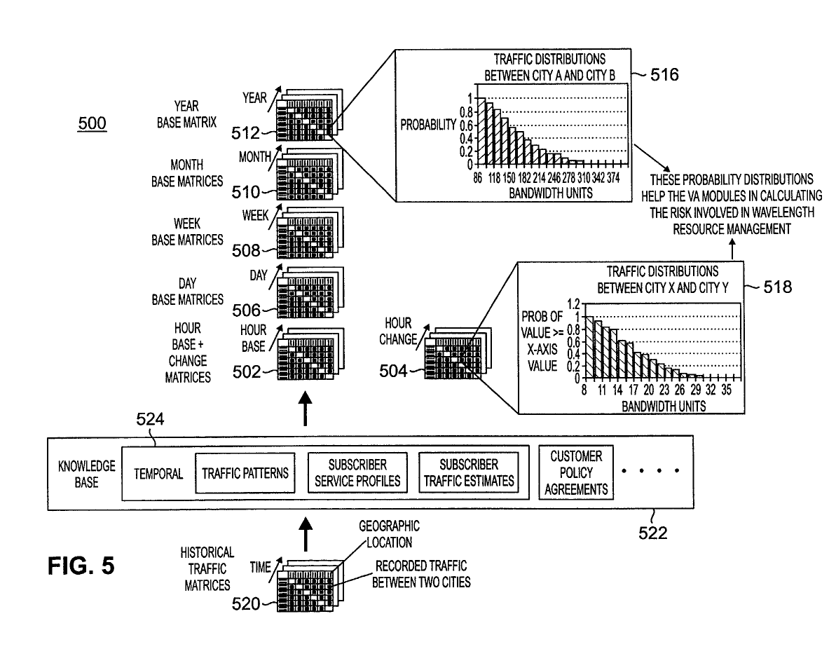

FIG. 5 depicts a flow diagram of generation and representation of dynamic traffic matrices 500. Specifically, FIG. 5 depicts temporal and spatial (knowledge) representations of dynamic traffic matrices 500, where the traffic matrices are organized into hierarchical clusters based on time, while the values in the matrices are represented as distributions to optimize space. From historical traffic matrices 520 and the knowledge base 504, traffic matrices for an hour are generated. Recall that the knowledge base 504 illustratively includes temporal information 524, such as traffic patterns, subscriber service profiles, and subscriber traffic estimates, as well as spatial information, such as customer policy agreements, and the like. A particular hour of traffic is represented by two sets of traffic matrices. A first set of traffic matrices 520 is composed of a base (invariant bandwidth in the hour) matrix, while the second set of traffic matrices 522 is represented as a set of dynamic change (variant bandwidth in the hour) matrices.

From the set of all hour invariant traffic matrices 502 of a particular day (e.g., all Mondays), an invariant traffic matrix of that day 506 is generated. From the set of invariant traffic matrices of all days in a week, an invariant matrix of a week 508 is generated. From the set of invariant traffic matrices of all weeks in a month, an invariant matrix of a month 510 is generated. From all the invariant traffic matrices of the months in a year, an invariant traffic matrix of the year 512 is generated. This process of generating invariant and variant traffic matrices can be carried out from a small time scale to a several year time window, depending on service provider needs. Because of the large amounts of information available, the matrix values are represented as distributions consolidating several matrices.

On the right hand side of FIG. 5, illustrative matrix elements 516 for the year base matrix 512 and illustrative matrix elements 518 for the hour change matrix 522, which are both generated by the behavior generation module using simulation algorithms, are shown. The exemplary traffic distributions between two cities in each illustrative matrix element 516 and 518 help the VA modules 240 calculate risk depending on the service provider's risk acceptance levels in utilizing their transport resources. The logical all-optical network design algorithms (e.g., mixed integer programming models) in the behavior generation modules 230 use these traffic matrices to route wavelengths in the network to allocate bandwidth on demand. The hierarchical organization of the matrices into variant and invariant matrices over time reduces the computational overhead and improves the performance of the algorithms to respond to changes in real-time. This helps in the automation of the bandwidth delivery technology needed for adaptable optical networks.

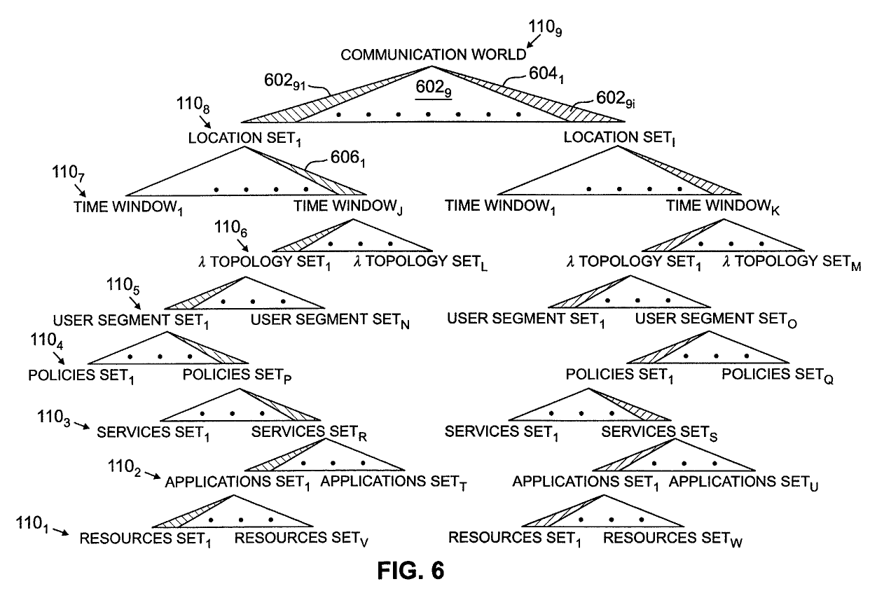

FIG. 6 depicts a flow diagram representing hierarchically arranged planning information structures. Planning implies an ability to predict future states of the world. Prediction algorithms typically use recent historical data to compute parameters for extrapolating into the future. Predictions made by such methods are typically not reliable for periods longer than the historical interval over which the parameters were computed. Thus at each level, planning horizons extend into the future only about as far, and with about the same level of detail, as historical traces reach into the past. Predicting the future state of the world often depends on assumptions as to what actions are going to be taken and what reactions are to be expected from the environment, including what actions may be taken by other intelligent agents or the end-users. Planning of this type requires search over the space of possible future actions and probable reactions. Search-based planning takes place via interactions between the BG 230, CWM 220, and VA 240 modules.

Referring to FIG. 6, several illustrative hierarchal levels of planning illustrating the planning horizon, as well as successive lower levels of the hierarchy are shown. At the top hierarchal level, a single task is decomposed into a set of planned subtasks for each of the sub-systems. At each of the following levels, a task in the plan of the subsystems is further decomposed into subtasks at the next lower level. For example, at the top hierarchal level 110₉ labeled “communication world”, a single task 602₉ is illustratively decomposed into a plurality of “I” subtasks 602₉₁ through 602₉ᵢ, which form the top triangle 604. At a lower hierarchal level 110₈, labeled “Location” and having a plurality of “location sets”, a single task in the first location set 1 is illustratively decomposed into a plurality of subtasks for the next lower hierarchal level “time window”, which is defined by triangle 606₁. The shaded areas of each subordinate triangle 604 from the top hierarchal level 110₈ represent end-to-end planning paths along the hierarchal levels of planning.

In particular, planning complexity grows exponentially with the number of steps in the plan (i.e., the number of layers in the search graph/domain space). If planning is to succeed, any given planning algorithm must operate in a limited search/domain space. If there is too much granularity in the time line, or in the space of possible actions, the size of the search graph can easily become too large for timely response.

One method of resolving this problem is to use a multiplicity of planners in hierarchical layers so that at each layer 110, no planner needs to search more than a given number of steps (e.g., ten steps) deep in a graph. Furthermore, at each level, a limited number of subsystem planners (e.g., ten subsystem planners) are required to simultaneously generate and coordinate plans. These criteria give rise to hierarchical levels with exponentially expanding spatial and temporal planning horizons, and characteristic degrees of detail for each level. At each level, plans consist of several subtasks. In a complex environment, plans must be regenerated periodically to cope with changing and unforeseen conditions in the network. Cyclic replanning may occur at periodic intervals. Emergency replanning begins immediately upon the detection of an unexpected event/condition (e.g., a severed cable or a node failure in a network or a fraud event.

Plan executors at each level have responsibility for reacting to feedback every response cycle interval. If the feedback indicates the failure of a planned subtask, the executor branches immediately (i.e., in one response cycle interval) to a preplanned emergency subtask. The planner simultaneously selects or generates an alternate/error recovery sequence that is substituted for the former plan that failed.

When a task goal is achieved at time t=0, the current task becomes a task completion event in the historical trace 404 (FIG. 4). To the extent that a historical trace 404 is an exact duplicate of a former plan, then the plan was followed without any unexpected surprises, that is, every task was accomplished as planned. To the extent that a historical trace 404 is different from the former plan, there were unexpected surprises. The average size and frequency of surprises (i.e., differences between plans and results) is a measure of effectiveness of the planning algorithms. At each level in the response hierarchy, the difference vector, as between planned (i.e., predicted) commands and observed events equates to an error signal, which may be used by executor sub-modules and by the VA modules 240 for evaluating success or failure.

Understanding the behavior of the users, applications, services, markets and other factors in the fast changing communications landscape and applying this knowledge to network management is a difficult problem to solve using the approaches that are traditionally employed in the current communication paradigm. A new paradigm based on self-organizing networks is introduced to efficiently manage large, complex networks and environments, and rapidly deploy, provision, and manage new, high-value services, with a corresponding reduction in manual intervention.

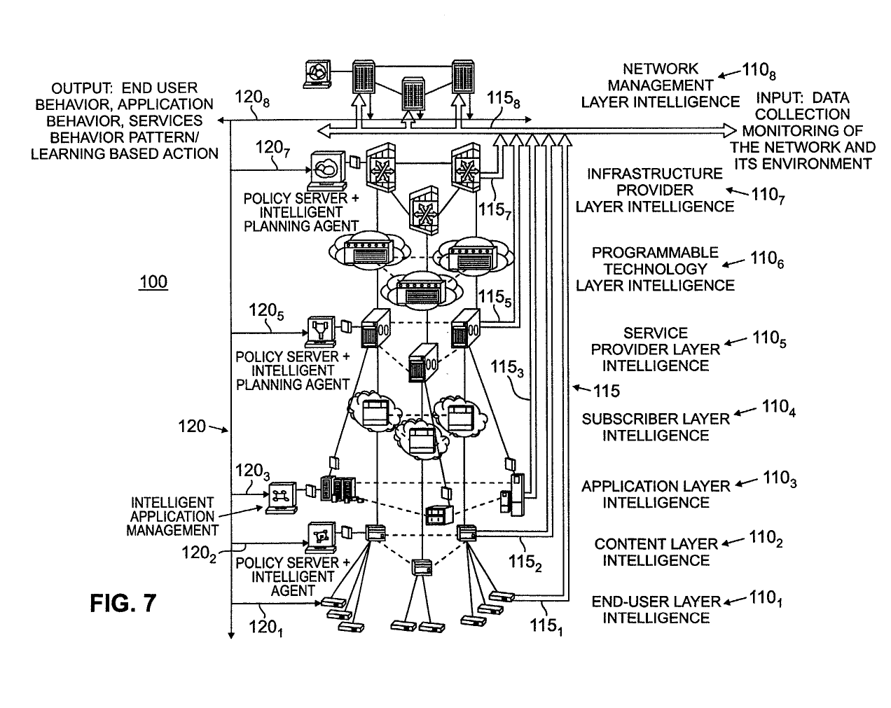

FIG. 7 depicts a flow diagram of functional end-to-end traffic flow for an automated, self-organizing hierarchal interconnected and layered intelligent network of FIG. 1. FIG. 7 is similar to FIG. 1, except that feedback loops are provided. The self-organizing capability of the intelligent network system 100 is obtained by using IRP feedback loops illustratively formed by input loops 115 and output loops 120. For example, input feed back loops 115₁, 115₂, 115₃, 115₅, and 115₇ are depicted as providing information from their respective hierarchal layers 110₁, 110₂, 110₃, 110₅, and 110₇ to the network management layer 110₈. Similarly, the network management layer 110₈ provides information back to the hierarchal layers 110₁, 110₂, 110₃, 110₅, and 110₇ via output feedback loops 120₁, 120₂, 120₃, 120₅, and 120₇.

The feedback loops 115 and 120 are provided to establish self-organizing intelligence, where the intelligent networks 100 may dynamically reconfigure network topologies, and provision resources and services dynamically. As such, the end-to-end intelligent network system 100 monitors, learns about its environment and its impact on the network resources, makes intelligent decisions and takes appropriate actions based on the network behavior observed in the past on an application or time or project driven basis.

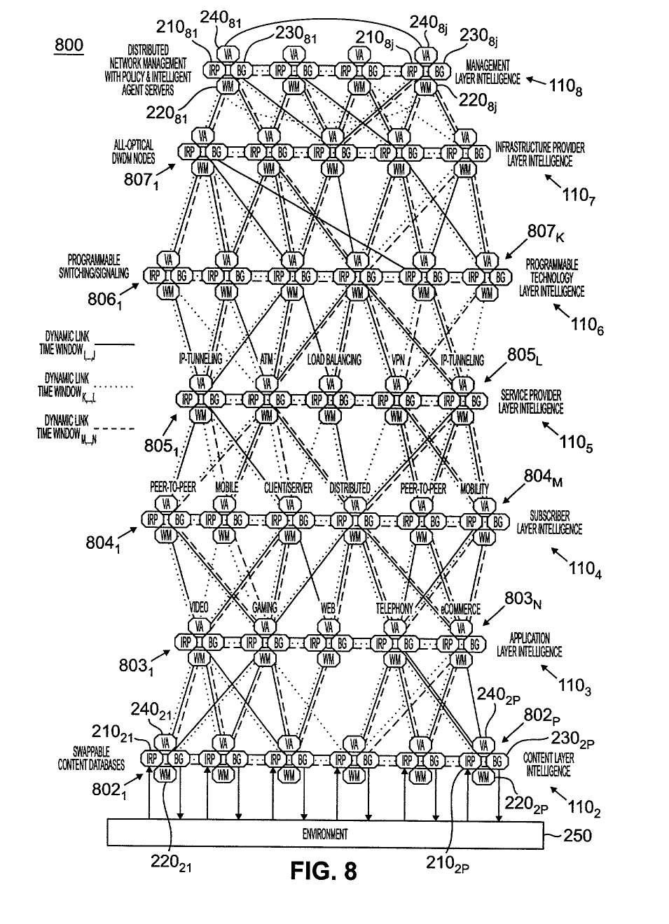

FIG. 8 depicts a flow diagram of dynamically interconnected layered network nodes representing the self-organizing network of FIG. 7. In particular, FIG. 8 shows the self-organizational in more detail, and illustrates both the hierarchical and horizontal relationships involved, based on the discussions regarding FIGS. 1-7 herein.

A plurality of hierarchal and horizontal nodes 802 though 808 are interconnected horizontally and vertically. For example, the management layer 110₈ comprises nodes 808ₗ, through 808ₖ, while the subordinate infrastructure provider layer 110₇ comprises nodes 807₁ through 807₁, and so forth down the hierarchal structure. It is noted that the number of nodes at each hierarchal layer 110 may vary. It is further noted that the end-user layer 110₁ is not shown in FIG. 8. Rather, the end-user layer 110₁ is considered part of the environment 250. As such, the IRP and BG modules 210₂ and 230₂ of the content layer 110₂ are shown as interfacing with the environment 250, rather than the end-user layer 110₁.

Each node at each hierarchal layer 110 is illustratively depicted by the four intelligence modules (i.e., the IRP module 210, the CWM module 220, the BG module 230, and the VA module 240), as shown and discussed with regard to FIG. 2. For example, the infrastructure provider layer 110₇ comprises a plurality of nodes 807ᵢ through 807ₖ, where the first node 807₁ further comprises IRP module 210₇₁, the CWM module 220₇₁, the BG module 230₇₁, and the VA module 240₇₁.

The architecture is hierarchical in that commands and status feedback flow hierarchically up and down a behavior generating chain of command. The architecture is also hierarchical in that input processing and world modeling functions have hierarchical levels of temporal and spatial aggregation, as discussed with regard to FIG. 4. During network operation, goal driven switching mechanisms in the BG modules 230 assess aggregate priorities, negotiate for resources, and coordinate task activities to select among the possible communication paths. As a result, each BG module 230 accepts task commands from only one supervisory process at a time, and hence the BG modules form a command tree at every instant in time.

The architecture is horizontal in that data is shared horizontally between heterogeneous network functional modules at the same level. At each hierarchical level, the architecture is horizontally interconnected by communication pathways between the BG, WM, IRP, and VA modules in the same node, and between nodes at the same level, especially within the same command sub-tree.

An organization of processing nodes is shown in FIG. 8, such that the BG modules 230 form a command tree. The functional characteristic of the BG modules 230 at each level, the type of environmental attributes/entities recognized by the IRP modules 210 at each level, and the type of processing subsystems form the command tree. The specific configuration of the command tree is service and application dependent, and therefore not necessarily stationary in time.

FIG. 8 illustrates three possible dynamic configurations that may exist at different points in time. These different configurations are shown by links in three different line formats, which are associated with different time windows. During operation, relationships between the intelligence modules 200 within and between the hierarchal layers may be reconfigured in order to accomplish different goals, priorities, and task requirements. Accordingly, any particular computational node, with its BG, WM, IRP, and VA modules, may belong to one subsystem at one time and a different subsystem a short time later. These configurations are obtained by the application of the automated planning process discussed in regard to FIG. 5, and the information collected from the spatial-temporal properties of the network elements and the network environment discussed in regard to FIG. 4.

The command tree reconfiguration may be implemented through multiple pathways that exist, but are not always activated, between the BG modules 230 at different hierarchical levels. These multiple pathways define a layered graph of nodes and directed arcs. They enable each BG module 230 to receive input messages and parameters from several different sources.

As discussed above, each layer of the system architecture contains a number of nodes, each of which contains BG, WM, IRP, and VA modules, and the nodes are interconnected as a layered graph, through the management communication network system. The nodes are richly but not fully, interconnected.

In an all-optical DWDM network elements layer illustratively shown in FIGS. 7 and 8, some of the outputs from the BG modules 230 drive the micro-mechanical mirror motor actuators, while the inputs to the layer IRP modules 210 convey data from the environment. During operation, goal driven communication path selection mechanisms configure this lattice structure into the organization tree shown as shown in FIG. 8. The IRP modules 210 are also organized as a layered graph. At each higher level, input information is processed into increasingly higher levels of abstraction, as input processing pathways may branch and merge in different ways.

For a better understanding of the invention, a few examples of specific layers and their functioning in a self-organizing network is provided. The Management layer 110₈ plans activities and allocates resources for one or more subordinate layers (e.g., layers 110₇ through 110₁) for a period specified in the historical trace patterns (FIG. 4). At the management layer 110₈, requests for provisioning, bandwidth orders, and the like are consolidated into batches for optimal resource utilization, and a schedule is generated for the layer(s) to process the batches.

Additionally, at the management layer, the CWM maintains a knowledge database containing names, contents, and attributes of batches and the inventory of resources required to provide the requested bandwidth and services. Historical traces may describe the temporal bindings of services, routing and bandwidth between nodes. The IRP processes compute information about the flow of services, the layer of inventory, and the operational status of all the nodes involved in the network 100. The VA module 240₈ computes the cost and benefits of various batches and routing options and calculates statistical service confidence data.

An operator interface allows service provider technicians to visualize the status of bandwidth and service requests, inventory, the flow of resources, and the overall situation within the entire network. Operators can intervene to change priorities and redirect the flow of resources and services. Planners keep track of how well plans are being followed, and modify parameters as necessary to keep on plan. The output from the management layer provides workflow assignments for the underlying nodes.

A second example illustrates the power of multi-layer intelligence using IP tunneling and optical switching nodes working together to provide agile networking. Using the optical network reconfigurability and IP tunneling capabilities together, service providers may optimize the use of their network resources. Today, the customers are capable of managing their own VPN network resources, by using automated network management and provisioning. Customer can establish service whenever and wherever it is needed. When bandwidth is available in a light path (unused, but allocated resource), the network management layer 110₈ utilizes the unused bandwidth to create a secure IP tunnel for another customers bandwidth request. For this kind of operation, the WM, BG, VA, and IRP modules of the optical layer (e.g., infrastructure provider layer 110₇ of FIG. 8) and the IP tunneling layer (e.g., service provider layer 110₅ of FIG. 8) have to work in synchronization sharing their CWM knowledge.

Illustrative types of CWM knowledge to be shared includes end points, Service Level Agreements (SLA) parameters, such as path characteristics, diverse routing requirements, include/exclude certain nodes in the path, quality of service (QoS) parameters like maximum delay, jitter, restoration types, an the like. Other types of CWM knowledge that is shared includes billing options, such as flat rate and usage based billing, as well as user authentication and authorization data. The Intelligent Tunneling BG modules provide processing-intense filtering, forwarding, accounting, and QoS/SLA functions in the tunneling switches. Furthermore, the CWM 220 maintains and the BG module 230 processes features that offer QoS, isolation, and policing capabilities that allow operators to deliver flexible, measurable, and enforceable SLAs to allow the delivery of real-time services over the network.

As such, tunneling switches are capable of configuring multiple dynamic Virtual Routers (VRs) with routing and policy domains that may be shared by any number of service providers. Large providers can be assigned dedicated VRs on the optical light path, while small providers may share VRs that are administratively managed by the service provider. The VA modules 240 perform evaluation and enforcement of network policies for admission control and rate limitations to ensure that all SLAs can be met while optimizing revenue from available network capacity.

Regarding the application layer of intelligence 110₃, one of the functions of the VA modules 240 that support the application layer of intelligence 110₃ is to provide CWM and BG modules 220₃ and 230₃ with ratings report for the applications at regular intervals of time. This information allows the BG modules 230 to isolate applications, which were used by more end-users than any other application on their network, on demand. This type of on-demand ratings generation capability of applications provides a service provider with a competitive edge, where a service provider can change the subscription plans to increase their bottom-line and redirect their other unused resources to support these high-flying applications.

In an end-to-end intelligent network, intelligence in an end-user device (end-user layer 110₁), when integrated properly with the other intelligent layers, plays a major role by contributing and utilizing of the intelligence in a network. The importance of the end-user layer 110₁ is significant because the amount of end-user behavioral information generated can be controlled at the end-user layer 110₁, where it originates, so that only useful information is communicated to the other layers of the intelligent network 100.

In this context, it is assumed that an end-user gateway device (e.g., a residential gateway, (not shown)) is integrated with intelligence gathering functionality, where the residential gateway monitors the end-user needs and behavioral patterns, and encodes the information into a data structure called an end-user diary. These intelligence-gathering mechanisms can automatically and invisibly keep track of the end-user(s) functions without creating an overhead on the network. The information collected is processed and communicated securely to the other intelligent network layers when the traffic on the network is minimal (e.g., during the nights).

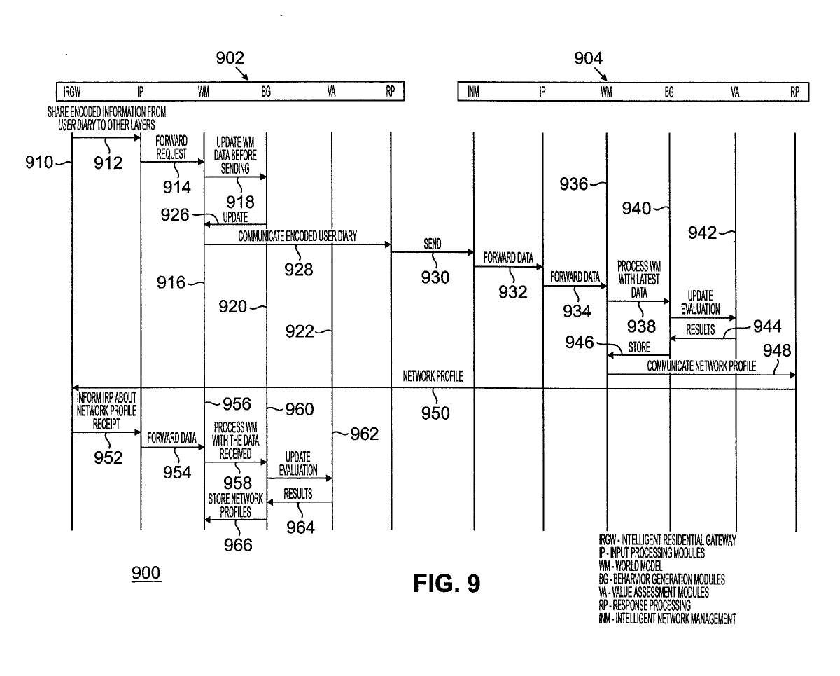

FIG. 9 depicts a flow diagram representing intelligence update control flow between an intelligent end-user gateway device and the intelligent network management layer 110₈. That is, FIG. 9 depicts the intelligence exchange flow between the IRP-WM-BG-VA modules 200 of the intelligent residential gateway and an intelligent network management layer IRP-WM-BG-VA modules. An intelligent residential gateway (IRGW) device and its respective intelligence modules (i.e., IP, WM, BG, VA and RP modules) are shown under column 902 on the left side of FIG. 9. Similarly, the intelligent network management (INM) layer 110₈ and its respective intelligence modules (i.e., IP, WM, BG, VA and RP modules) are shown under column 904 on the right side of FIG. 9.

The intelligent network management layer 110₈ receives all the end-user diaries and updates the user profile database. In return the intelligent network management layer 110₈ sends each end-user gateway device, information about the predicted traffic load on the network layers for the following day based on expected end-user service needs for the next day. The status of the network information allows the behavior generation modules of the intelligent network management layer 110₈ to make better choices in selecting network routes and application servers among the available alternatives for service.

In particular, at step 910, the IRGW encodes an end-user information request into the end-user diary and at step 912, the encoded information is sent to the input processing module 215₁, which forwards the request for information, at step 914, to the CWM module 220₁. At step 916, the CWM module 220₁ is updated, as discussed with regard to FIG. 2, and at step 918, the information is sent to the BG module 230₁. At step 920, the BG module 230₁ selects goals, initiating plans, and executing tasks and subtasks to achieve the goals within the plans.

At step 922, the VA module 240₁ evaluates both the observed state of the world and the predicted results of hypothesized plans. That is, the value assessment module 240₁ computes costs, risks, and benefits both of observed situations and of planned activities, as well as the probability of correctness and assigns believability and uncertainty parameters to state variables.

At step 924, the results of the VA module 240₁ are sent back to the BG module 230₁, where particular plans and tasks are selected. At step 926, the CWM module 220₁ is updated with newly generated/recognized entities, states, and events, which are stored in the knowledge database 222. At step 928, the RP module 232 receives the updated encoded user diary containing the end-user needs and behavioral patterns, as well as the plans and tasks generated by the BG and VA modules 230₁ and 240₁. At step 930, the updated encoded user diary (data) is sent to the INM hierarchy layer 110₈.

In particular, at step 932, the data is sent to the input processing module 215₈ of the network management layer 110₈. Steps 934 through 948 are performed at the network management layer 110₈ in the same manner as described with regard to the IRGW device in steps 914 through 928. At step 950, the results from network management layer 110₈ are sent back to the IRGW device.

At step 952, the data from the network management layer 110₈ is sent to the input processing module 215₈ of the IRGW device. Steps 954 through 966 are performed at the IRGW device in the same manner as described with regard to the IRGW device in steps 914 through 926.

It is noted that within the proposed framework, each layer would control and resolve issues within its purview. At each layer, the inputs and requests are received and reactions are planned by the input processing module 215, evaluated according to the communications world model 220 by the value assessment engine 240 and implemented by the behavior generation subsystem 230. In the above example, the network management layer creates and modifies the networking and subnet structure and assigns end-users within that structure to provide the most reasonable administrative structure according to the rules and policies of the service provider.

The specific functions given in the above examples are for illustrative purposes only. They are meant only to illustrate how the generic structure and function of the proposed framework might be instantiated by a service provider. The purpose of these examples is to illustrate how multi-level hierarchical architecture integrates real-time planning and execution behavior with dynamic world modeling, knowledge representation, and input. At each level, behavior generation 230 is guided by value assessments that optimize plans and evaluate results. The system architecture organizes the planning of behavior, the control of action, and the focusing of computational resources. The overall result is an intelligent real-time self-organizing network system 100 that is driven by high-level goals and reactive to input feedback. One benefit of the self-organizing intelligent network 100 is to enable service providers to efficiently utilize the network resources based on network needs that are dependent on the spatial-temporal changes in the network 100, itself, and changes in network environment 250.

Although various embodiments that incorporate the teachings of the present invention have been shown and described in detail herein, those skilled in the art can readily devise many other varied embodiments that still incorporate these teachings.

What is claimed is:

1. An intelligent network, comprising:
a plurality of hierarchal intelligent layers, each layer responsive to communications from at least one of a superior layer and a subordinate layer;
a plurality of nodes forming each layer, each of the plurality of nodes having intelligence modules and interconnected horizontally within each layer and interconnected to intelligence modules of the subordinate and superior hierarchal layers, wherein the intelligence is provided end-to-end of the hierarchal self-organizing intelligent network.

2. The intelligent network of claim 1, further comprising feedback loops between the superior and subordinate layers.

3. The intelligent network of claim 1, wherein the hierarchal intelligent layers comprise layers selected from the group consisting of at least two of a network management layer, an infrastructure provider layer, a programmable technology layer, a service provider layer, a subscriber layer, an application layer, a content layer, and an end-user layer.

4. The intelligent network of claim 1, wherein each of intelligence module comprises an input processing module, response processing module, a communications world model (CWM) module, a behavioral generation (BG) module, and a value assessment (VA) module in communication with each other.

5. The intelligent network of claim 4, wherein said input processing module receives inputs to the intelligent network system, compares input observations with expectations generated by the CWM module, and communicates observed entities, events, and perceived situations to the VA modules.

6. The intelligent network of claim 5, wherein the BG module hypothesizes plans, the CWM module predicts results of such plans, and the VA module evaluates those results.

7. The intelligent network of claim 6, wherein said CWM module further comprises a database for storing information regarding about the network and network environment.

8. The intelligent network of claim 7, wherein the CWM module provides current status of said network and network environment from automated planners and executors of the BG modules.

9. The intelligent network of claim 7, wherein said CWM module generates expectations and predictions about network resources, operations, usage; and
responds to requests for information about present, past, and probable future states of the world.

10. The intelligent network of claim 9, wherein said CWM module performs simulation functions of actions hypothesized by the BG modules;
predicted results are sent to the VA module for evaluation; and
said evaluation results are sent to said CWM module to answer hypothetical queries from automated planners and executors of the BG modules.

11. The intelligent network of claim 7, wherein said CWM module generates predictions enabling the IRP module to perform correlation and predictive filtering, where said CWM model database is updated based on said correlations and differences between said CWM module predictions and observations of input data at each intelligent network node.

12. The intelligent network of claim 6, wherein said BG module
selects for execution, said plans with highest evaluations:
monitors execution of said selected plans; and
modifies existing plans in response to changes in said network and network environment.

13. The intelligent network of claim 1, wherein the intelligence modules at each node utilize historical information gathered as each node to formulate decisions for future actions.

14. The intelligent network of claim 13, wherein the intelligence modules select goals and plans, and executes tasks, said tasks are recursively decomposed into subtasks, and said subtasks are sequenced to achieve said goals.

15. The intelligent network of claim 7, wherein said input processing, response processing, WM, BG and VA modules at each node of each network layer aggregately define a hierarchal intelligence across the network.

16. The intelligent network of claim 15, wherein said BG modules at each network layer:
decompose tasks commands into subtask commands;
input commands and priorities from other BG modules at a higher network layer, evaluations from VA modules, and information regarding past, present, and predicted future states of said network environment from CWM modules;
provide subtask commands to BG modules at lower network layers; and
provide status reports regarding current and future states of the network and network environment to the CWM modules.

17. The intelligent network of claim 7, wherein said VA modules determine importance, risk, and probability associated with events and actions involved in said intelligent network.

18. The intelligent network of claim 17, wherein said VA modules:
evaluates observed states of said network and network environment and hypothesized plans;
costs, risks, and benefits are computed for the observed state and said hypothesized plans,
probability and correctness of state variables are determined;
credibility and uncertainty values are assigned to said state variables; and
said evaluated plans are sent to said BG module for subsequent selection.

19. A method of providing intelligence to a network having a plurality of network layers, at each layer said method comprising:
a) establishing goals to be performed by a first layer;
b) providing input to a database storing information regarding the network and network environment;
c) hypothesizing plans to accomplish said goals at said first layer;
d) predicting results of said hypothesized plans;
e) evaluating said predicted results;
f) selecting plans with the highest evaluations for execution;
g) updating said database;
h) sending an output response to at least one of a superior and subordinate layer to said first layer;
i) repeating steps a through h for all of the network layers; and
j) executing said selected plans.

20. The method of claim 19, further comprising:
monitoring said selected plans; and
modifying said selected plans as required.

21. The method of claim 19, further comprising:
defining a plurality of tasks defining said selected plans.

22. The method of claim 21, further comprising:
decomposing said plurality of tasks into subtasks that become task commands for a subordinate network layer.

23. The method of claim 22, further comprising:
providing feedback regarding completion of said tasks and subtasks from subordinate network layers up to superior network layers.

24. A system architecture, comprising:
a plurality of functional layers for providing respective functions within a hierarchy of functions, each of said functional layers including a respective agent for vertically propagating information between hierarchically adjacent layers, each of said functional layers including at least one element for implementing at least one respective layer function; wherein
each functional layer agent, in response to a respective task-indicative subset of said vertically propagated information, horizontally propagating to respective functional layer elements at least that information necessary to perform an indicated task; and
each functional layer agent vertically propagating information pertaining to said indicated task.

25. The system architecture of claim 24, wherein:
in the case of a multiple layer task, each of said plurality of functional layers responding to a respective task-indicative subset of propagated information associated with said multiple layer task.

26. The system architecture of claim 24, wherein said system architecture defines an intelligent communications system to provide an automated network planning function.

27. The system architecture of claim 26, wherein said automated network planning function comprises an intelligent network management for optimal utilization of network resources.

28. A system architecture, comprising:
a plurality of functional layers for providing respective functions within a hierarchy of functions, each of said functional layers including a respective agent for vertically propagating information between hierarchically adjacent layers, each of said functional layers including at least one element for implementing at least one respective layer function; wherein
each functional layer agent, in response to a respective task-indicative subset of said vertically propagated information, horizontally propagating to respective functional layer elements at least that information necessary to perform an indicated task; and
each functional layer agent vertically propagating information pertaining to said indicated task.

29. A method of managing a communication network, comprising:
establishing a plurality of traffic matrices arranged in a temporally hierarchical order, each of said traffic matrices comprising a corresponding plurality of elements for storing risk probability data associated with respective traffic parameters;
adapting an operating parameter of said communications network in response to changes in traffic patterns associated with risk probability as a function of time.

30. The method of claim 29, wherein said risk probability data associated with respective traffic patterns comprises traffic distribution data.

31. A system, comprising:
a plurality of functional layers for providing respective functions within a hierarchy of functions, each of said functional layers including a respective plurality of functional elements, each of said functional elements being associated with one of a plurality of element types; wherein
each of said functional elements communicates horizontally with functional element within the same functional layer and communicates vertically with functional elements of the same type within hierarchically adjacent functional layers, said horizontal communications being processed by said functional elements in a manner tending to improve at least one of an individual element function and a system function.

32. The system of claim 31, wherein said vertical communication includes facilitating communications between functional elements of the same type within hierarchically nonadjacent functional layers.

33. The system of claim 31, wherein said system function comprises at least one of a network organizational hierarchy model and a network behavioral hierarchy model.

34. The system of claim 31, wherein each functional element comprises:
a communications system model, for storing data indicative of a hierarchical model of a system within which the functional element operates, said communications system model being updated in response to input events and changes in value assessments.

35. The system of claim 34, wherein each functional element further comprises:
an input processing module to processes observed input events and predicted input to responsively produce perceived situation data, said predicted input provided by said communications system model;
a value assessment module, to process said perceived situation data and plan result data to responsively produce plan evaluation data, said plan result data provided by said communications system model; and
a behavioral generation module, to process said plan evaluation data to responsively produce a command adapted to be execution by an entity other than the functional element.
